(19) United States
(12) Patent Application Publication
(10) Pub. No.: US 2011/0087365 A1
(43) Pub. Date: Apr. 14, 2011

(54) MAILPIECE SENDING SYSTEM WITH HANDWRITTEN SIGNING

(75) Inventor: François ARNOUX, Laon (FR)

(73) Assignees: NEOPOST TECHNOLOGIES, Bagneux (FR); NEOPOST SOFTWARE & INTEGRATED SOLUTIONS, Ruti (CH)

(21) Appl. No.: 12/895,117

(22) Filed: Sep. 30, 2010

(30) Foreign Application Priority Data
Oct. 1, 2009 (FR) 0956856

(51) Int. Cl. G06F 7/00; B65H 39/00; B41L 45/00

(52) U.S. Cl. 700/222; 101/47

(57) ABSTRACT

In a mail-handling system comprising computer processing means associated with first print means so as to place at least one unique send number on an empty envelope and with second print means for printing at least one document, and an envelope-stuffing machine for inserting said at least one document into the empty envelope, said mail-handling system further comprises a signing set for writing, by means of a writing instrument, a recipient's address on each of the envelopes bearing said unique send number and delivered to the signing set. Said recipient's address is extracted from a database connected to the computer processing means and being indexed in the database with the unique send number borne by the envelope. The envelope-stuffing machine includes read and decode means for extracting the single send number borne on the empty envelope and for ensuring that it matches the document on the basis of the database.

### TECHNICAL FIELD

The present invention relates exclusively to the field of mail handling, and it relates more particularly to a mail handling system making it possible for mailpieces bearing handwritten addresses to be sent automatically.

### STATE OF THE ART

Nowadays, sales prospecting by mail is a daily occurrence, and recipients find it difficult to distinguish between mailpieces that are of real interest to them and mailpieces that are merely direct marketing or advertising. In practice, both types tend to be thrown away, which is unfortunate for certain senders who have invested considerable amounts of money in the hope of reaching the targeted prospective customers or “prospects”.

This applies, in particular, to firms in the luxury sector or private banks who purchase customer files at great expense, and who want a good return on their investment through the high-potential prospects contained in such files becoming interested in their products. That is why, in general, in order to avoid them having the appearance of machine-processed mail, certain mailpieces sent to that type of customer are not sent through the standard mail systems, but rather they undergo a specific process that is essentially manual and in which, for example, the recipient addresses are written one-by-one and by hand. That results in very lengthy and costly processing, and it would be opportune to reduce significantly the duration and the cost of such processing.

### DISCLOSURE OF THE INVENTION

An object of the present invention is to mitigate the above-mentioned drawbacks by proposing a novel automated mail-handling system that makes it possible to send documents, in particular bank documents, in envelopes of the windowless type, that do not have the appearance of machine-processed mail. This object is achieved by a mail-handling system comprising computer processing means associated with first print means so as to place at least one unique send number on an empty envelope, second print means for printing at least one document, and an envelope-stuffing machine for inserting said at least one document into said empty envelope, wherein said mail-handling system further comprises a signing set for writing, by means of a writing instrument, a recipient's address on each of the envelopes bearing said unique send number and delivered to said signing set, said recipient's address being extracted from a database connected to said computer processing means and being indexed in said database with said unique send number borne by said envelope, and wherein said envelope-stuffing machine includes read and decode means for extracting said single send number borne on said empty envelope and for ensuring that it matches said document on the basis of said database.

Thus, by using a signing machine and by checking for matching between the documents and the envelopes into which said documents are inserted, it becomes possible to prepare, automatically and industrially, mailpieces that, for their recipients, have the appearance of handwritten mail that is addressed to them personally.

Advantageously, said computer processing means are constituted by a general-purpose computer.

Depending on the embodiment, said first print means comprise a label printer printing a postal mark on a label that is then to be stuck to said empty envelope, or a laser printer printing a postal mark on said empty envelope, or indeed said computer processing means and said first print means together form a franking machine printing a postal mark on said empty envelope and delivering a franked envelope to said signing set.

Advantageously, said second print means comprise a laser printer for printing said document.

Preferably, said signing set comprises at least one singing machine including said writing instrument. When said signing set comprises a plurality of signing machines, said signing set includes as many read and decode means for reading and decoding said unique send number as there are signing machines, said read and decode means also transmitting said unique send number to said database.

### BRIEF DESCRIPTION OF THE DRAWINGS

Other characteristics and advantages of the present invention appear more clearly from the following description given by way of non-limiting indication, and with reference to the accompanying drawings, in which:

FIG. 1 shows an example of a mail-handling system of the invention;

FIG. 1A shows an alternative example of a mail-handling system of the invention;

FIG. 1B shows the various records implemented in the databases of the mail-handling system of FIGS. 1 and 2;

FIG. 2 shows the document-processing stage during which documents are processed in the mail-handling system of the invention;

FIG. 3 shows the document-insertion stage during which the documents are inserted into the envelopes in the mail-handling system of the invention;

FIG. 4 shows a checking stage that can be implemented in the mail-handling system of the invention; and

FIG. 5 shows another example of a mail-handling system of the invention.

### EMBODIMENTS OF THE INVENTION

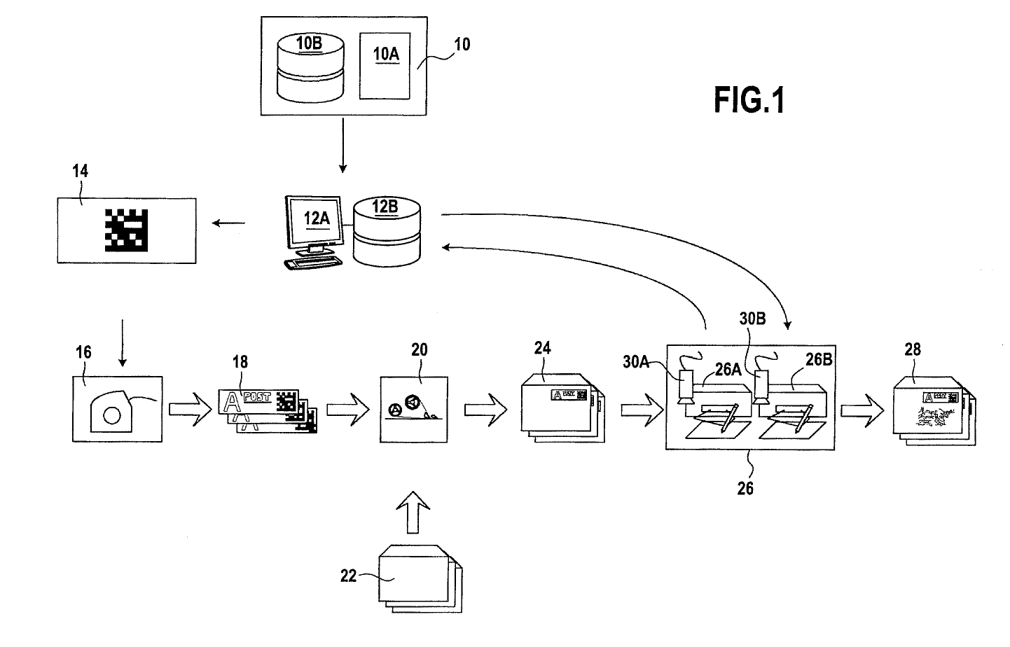

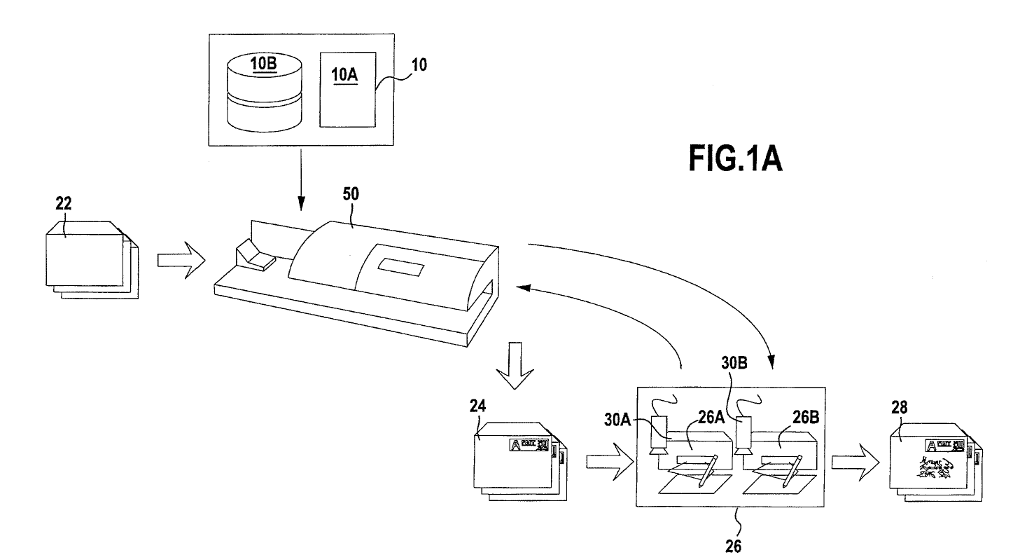

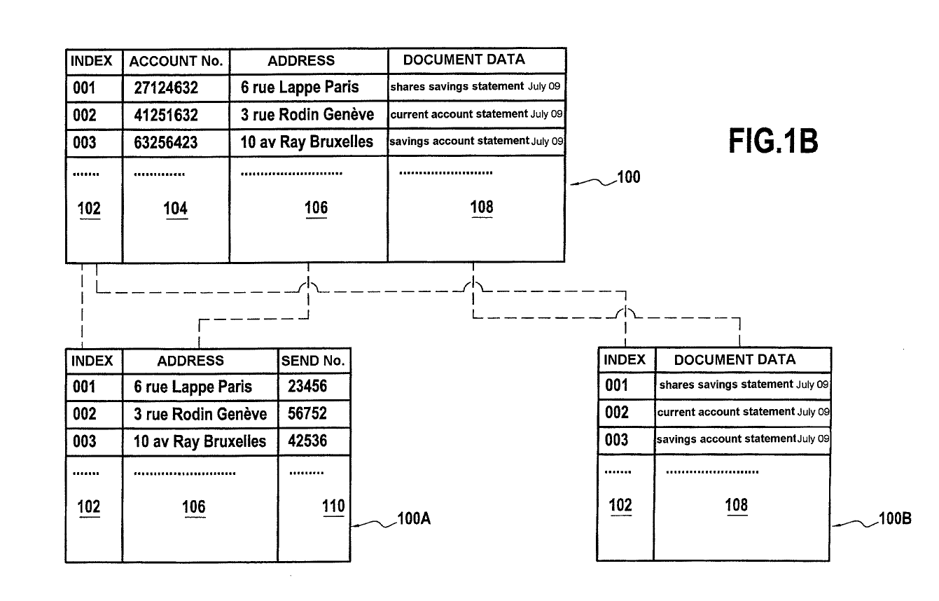

FIGS. 1 to 3 show an architecture of a mail-handling system that makes it possible, in communication with a bank computer system, to implement the invention in the context of bank use consisting in sending a particular item of mail to a determined list of people, it being necessary for that item of mail to have a personal and confidential appearance and thus not to have any sign of being machine-processed mail. In particular, the recipient's address must be a handwritten address. This mail-handling system is preferably of the open type, i.e. the postal mark is printed from standard, non-secure, print means, from a general-purpose computer of the desktop or personal computer type, for example, that is in communication with the bank computer system from which it receives some of its information. However, it can also be of the closed type, with the postal mark being printed from a standard postage meter or “franking machine”, as shown in FIG. 1A.

More precisely, as shown in FIG. 1, the bank computer system 10 comprises a computer set 10A and a database 10B containing all of the banking data necessary for processing customer accounts. The contents of this database are shown in FIG. 1B. It contains an indexed list 100 in which each indexing number 102 is associated with a customer account number 104, with a customer address 106, and with data 108 corresponding to the document to be sent to the customer. That document may be an offer of services for a prospect or for a customer, or a bank statement once the prospect has become a customer.

The bank computer system is in communication with computer processing means, of the general-purpose computer type 12A, of the mail-handling system, which computer manages franking by means of software 14 approved by the postal authority and making it possible to generate postal marks. This computer is associated with a database 12B containing data extracted from the bank database and necessary for performing the franking. More particularly, and as shown again in FIG. 1B, this database contains a first indexed list 100A in which each indexing number 102 is associated with the customer's address 106, and with a unique send number 110, generation of which is described in more detail below, and a second indexed list 100B in which each indexing number 102 is associated with data 108 corresponding to the document to be sent to the customer. It should be noted that these two lists do not contain the customer account number which is therefore known only to the bank. In practice, these various details are sent by the computer system 10 to the franking management computer 12A a few days before the end of the month if, for example, monthly statements are to be sent out.

In the example shown, the management computer 12A is connected to a label printer 16 that generates a batch of labels, the number of labels in the batch corresponding to the number of recipients in the list, and each label bearing a postal mark. The outlet of this printer that delivers the labels 18 is connected to a first inlet of a label paster 20 that receives empty envelopes of the windowless type 22 at its second inlet and that thus delivers envelopes 24 that are still empty but that are franked at its outlet.

The postal marks can, as shown, be of the “paid on validation” type without any indication of weight or price (“A Post” product from the Swiss postal authorities), merely with an issuer number, a batch number, and a unique send number that are encoded in a two-dimensional bar code. But such postal marks can also conventionally include a franking amount or “postage amount” that depends on the contents of the mailpieces, and that is entered into the software 14 or computed automatically thereby. In a particular embodiment, the postal mark can be limited to printing of the unique send number, e.g. encoded in the form of a “datamatrix” code that is then covered and therefore masked by a conventional stamp at the end of the printing process for the purpose of further reinforcing the manual nature of the mailpiece. In this situation, the software used does not need to be approved by the postal authority because the marks or the mere numbers that are printed then do not have any monetary value.

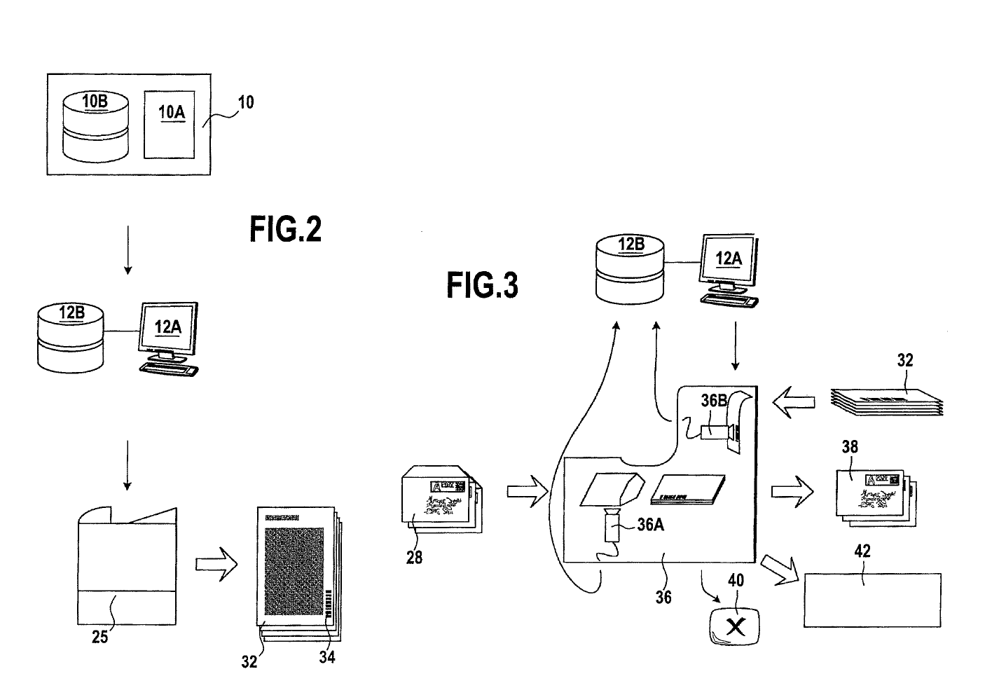

In a variant (not shown), the postal marks or the “datamatrix” codes acting as postal marks can be printed directly on the envelopes then fed into a conventional printer of the laser type or of some other equivalent type (referenced 25 in FIG. 2) connected directly to the computer 12A and serving to print the documents. Naturally, it is also possible to use two different printers.

At the outlet of the printer or of the label paster 20, a signing set 26 is disposed that is formed by one or preferably more signing machines 26A, 26B, the loader of which set receives franked or merely numbered empty envelopes 24. Said signing set delivers at its outlet franked or merely numbered empty envelopes 28 whose addresses have been written, as if by hand, by means of a writing instrument. In view of the relatively slow speed at which these machines write, in view of the time available, and in view of the number of mailpieces to be sent, it is preferable to use a plurality of signing machines disposed in parallel, each machine printing a given batch of envelopes, or possibly disposed in series one after another, each machine then writing only one line of each address (in which case four of five machines suffice). The writing time required for writing the addresses might be as long as several days if the number of signing machines is not dimensioned sufficiently to accommodate the number of mailpieces to be processed. The writing is performed by each signing machine by means of a fountain pen, of a ball-point pen, of a felt-tip pen, or of any other writing instrument desired by the sender.

The signing set 26 further includes one or more read devices 30A, 30B, the number of which is equal to the number of signing machines, for reading and decoding the unique send numbers borne on the labels or printed on the empty envelopes, and for transmitting them to the management computer 12A to which it is connected and that can thus associate them with the successive addresses of the various customers 106 in their order of arrival, in a new space 110 of the indexed list 100A.

In return, for performing the writing, the signing set receives from the management computer 12A the various addresses in the form of one or more lists depending on whether it uses one or more signing machines, so as to write the addresses on the labeled envelopes in the order of indexing. Once all of the envelopes have passed through the signing set, the first indexed list 100A is filled in and gives the correspondence between the various addresses and the various unique send numbers.

FIG. 1A shows an alternative embodiment of the mail-handling system of the invention, in which embodiment the general-purpose computer 12-14, the printer 16 or 25, and the label paster 20 are replaced with a franking machine 50 designed to print the postal mark directly on the empty envelopes 22.

Printing the documents is shown in FIG. 2. When all of the required data is available, the bank computer system 10 that has been informed that said data is available sends the second indexed list to the management computer 12A or to the franking machine 50 (unless they have received it automatically and previously), which second list contains the data records to be printed and their indexing numbers, so that it can print the documents 32 on a printer 25, advantageously of the laser type or of some similar type, in the same order as the addresses while placing a bar code 34 on said documents for envelope stuffing management and document identification purposes. If no document is present for a given recipient to whom a previously franked envelope is to be allocated, a place-holder document is then generated so as not to lose the synchronization of the succession of ordered documents generated in this way. Insertion of these documents into their envelopes is described below with reference to FIG. 3.

The batch of franked envelopes 28 is loaded into an envelope-stuffing machine 36, as is the corresponding batch of documents 32 to be inserted into said envelopes.

The first envelope is loaded by the machine, and the associated encoded unique send number (datamatrix encoded, for example), as read and decoded by a first reader 36A of the machine, is then sent to the management computer 12A or to the franking machine 50 that then deduces the corresponding indexing number therefrom on the basis of the first indexed list 100A. The documents are taken page after page, and their bar codes are read and decoded by a second reader 36B (but naturally, depending on the configuration of the machine, the first reader 36A could equally well have read and decoded them) before they are transmitted to the management computer 12A or to the franking machine 50 for checking, whereupon correlation is effected between the waiting envelope and the current document that is also waiting. If a match is found, an insertion authorization is sent to the machine. Otherwise, an error message is sent to the user interface 40, and the non-stuffed envelope and the non-recognized document are sent to a reject tray 42 of the envelope-stuffing machine, from which tray the user can retrieve them.

At the end of the envelope stuffing process, a work progress statement can be displayed on the user interface with, for example, a list of the envelopes not stuffed/documents not inserted that are available in the reject tray.

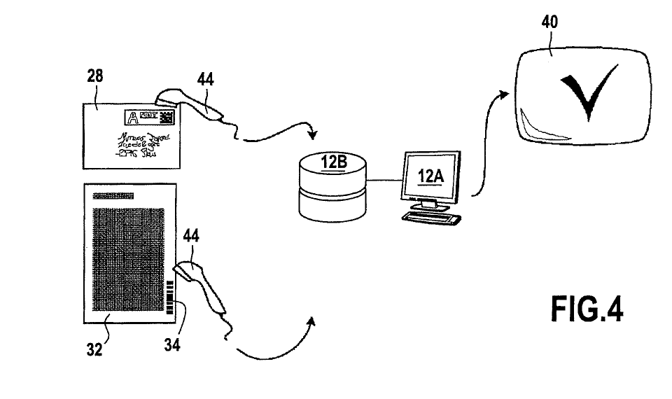

Processing of the rejected documents is described below with reference to FIG. 4.

In order to re-synchronize the rejected documents, a system for checking the envelope/document match is made available to the user. By using manual scanner means (handheld scanner of the “triggerless” type 44), the user can read the bar codes 34 on the documents and the datamatrix-type codes present on the labels 18 of the franked envelopes 28. The information relating to matching between the envelope and the document is transmitted to the user via the user interface 40, and the user can thus associate a given envelope with the matching document.

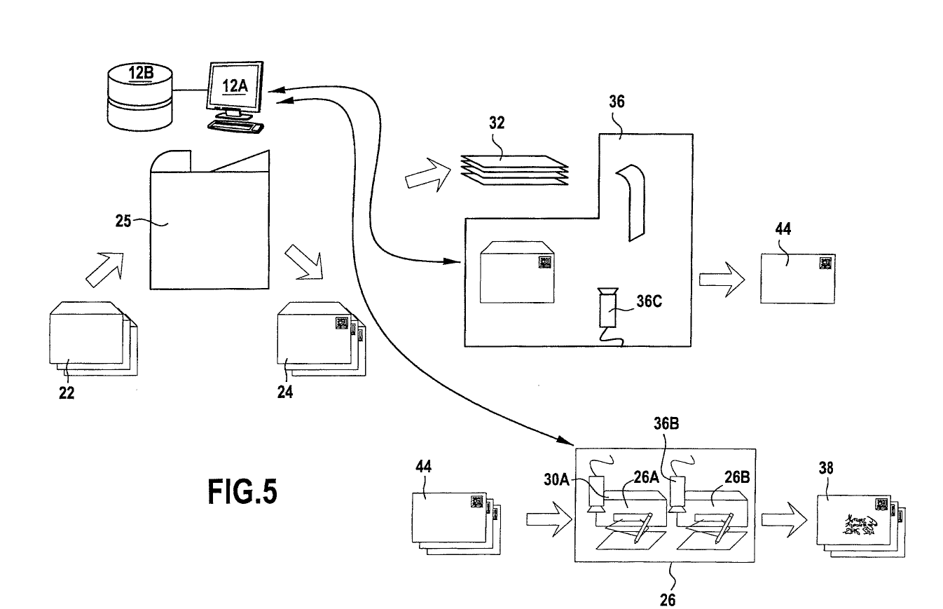

It should be noted that although, in the preceding examples, the signing machines operate on empty envelopes, it is naturally also possible for them to operate on closed envelopes, as shown by the embodiment of FIG. 5.

In this embodiment, the printer (advantageously a laser printer) 25 prints both the documents 32 and the empty envelopes 22 on which it prints the unique send number or the postal mark 18 incorporating said unique send number if the management computer 12A includes the appropriate approved software. The documents 32 are then inserted into the resulting printed empty envelopes 24 by means of the envelope-stuffing machine 36, the read and decode means (e.g. the single means 36C) of this machine ensuring that the envelopes and the documents match, on the basis of the database 12B of the management computer. At the outlet of this machine, closed envelopes 44 are available. Each of them is provided with at least the unique send number and possibly with a postal mark incorporating said unique send number, but is not provided with any indication of recipient and therefore of address. It is this unaddressed closed envelope that can be fed into the signing set 26 for the purpose of writing the recipient's address on it, reading and decoding of the unique send number by the read devices 30A, 30B making it possible, after transmission to the management computer 12A to which it is connected, to write the address that is associated with said unique send number in the database 12B, and to deliver a closed envelope 38 with the recognized address. When the closed envelope bears a postal mark 18, the franking process is finished, and the envelope franked in this way can be delivered to its recipient. However, if the envelope merely has a unique send number, e.g. a datamatrix code, that number needs to be covered by a stamp in order to enable it to be delivered via the postal network, or else the envelope needs to be passed through a franking machine.

What is claimed is:

1. A mail-handling system comprising computer processing means associated with first print means so as to place at least one unique send number on an empty envelope, second print means for printing at least one document, and an envelope-stuffing machine for inserting said at least one document into said empty envelope, wherein said mail-handling system further comprises a signing set for writing, by means of a writing instrument, a recipient's address on each of the envelopes bearing said unique send number and delivered to said signing set, said recipient's address being extracted from a database connected to said computer processing means and being indexed in said database with said unique send number borne by said envelope, and wherein said envelope-stuffing machine includes read and decode means for extracting said single send number borne on said empty envelope and for ensuring that it matches said document on the basis of said database.

2. A system according to claim 1, wherein said computer processing means are constituted by a general-purpose computer.

3. A system according to claim 2, wherein said first print means comprise a label printer printing a postal mark on a label that is then to be stuck to said empty envelope.

4. A system according to claim 2, wherein said first print means comprise a laser printer printing a postal mark on said empty envelope.

5. A system according to claim 1, wherein said computer processing means and said first print means together form a franking machine printing a postal mark on said empty envelope and delivering a franked envelope to said signing set.

6. A system according to claim 1, wherein said second print means comprise a laser printer for printing said document.

7. A system according to claim 1, wherein said signing set comprises at least one singing machine including said writing instrument.

8. A system according to claim 7, wherein said signing set includes as many read and decode means for reading and decoding said unique send number as there are signing machines, said read and decode means also transmitting said unique send number to said database.

9. A system according to claim 1, wherein said unique send number is a datamatrix code.
